(19) United States
(12) Patent Application Publication
(10) Pub. No.: US 2024/0023496 A1
(43) Pub. Date: Jan. 25, 2024

(54) Weed and Grass Barrier Device

(71) Applicant: Judy Grant, Louisville, KY (US)

(72) Inventor: Judy Grant, Louisville, KY (US)

(21) Appl. No.: 18/355,135

(22) Filed: Jul. 19, 2023

Related U.S. Application Data
(60) Provisional application No. 63/390,448, filed on Jul. 19, 2022.

(51) Int. Cl. A01G 9/28

(52) U.S. Cl. CPC A01G 9/28

(57) ABSTRACT

A barrier device for preventing the growth of weeds and grass in various outdoor areas. The barrier device is made of weatherproof materials such as vinyl or rubber and comes in the form of a roll, enabling users to cut the desired length along perforation lines according to their requirements. The barrier device features a rectilinear shape with a horizontal member for laying over the desired area, a pair of vertical members extending downwards from the longitudinal edges of the horizontal member, the vertical members form a 90-degree angle with the horizontal member, providing a secure grip and preventing shifting or displacement of the barrier device. A plurality of recessed grooves or slits on the horizontal member facilitate water drainage to prevent water accumulation on the barrier device and enable application of weed killer under the horizontal member.

### CROSS-REFERENCE TO RELATED APPLICATION

The present application claims priority to, and the benefit of, U.S. Provisional Application No. 63/390,448, which was filed on Jul. 19, 2022 and is incorporated herein by reference in its entirety.

### FIELD OF THE INVENTION

The present invention generally relates to the field of weeds and grass prevention devices. More specifically, the present invention relates to a novel device that can be placed along sides or edges of sidewalks, driveways, garden areas, and more for preventing growth of weeds, grass, and other vegetation. The device is made of vinyl and rubber and can come in the form of a roll with perforation lines. The device is reusable and obviates the need to use string trimmers and other grass or weed cutting tools. Accordingly, the present disclosure makes specific reference thereto. Nonetheless, it is to be appreciated that aspects of the present invention are also equally applicable to others like applications, devices, and methods of manufacture.

### BACKGROUND

By way of background, unwanted vegetation and especially weeds and grass commonly grow along edges of sidewalks, garden areas, and other places. Weeds and grass thrive in sidewalk cracks and other areas where individuals frequently walk, which can create a tripping hazard and pose a safety risk. Further, weeds and grass can provide food and shelter for pests which can be dispersed on sidewalks, driveways, and more. Individuals generally use a lawnmower to keep the grass at a desired height and for maintenance of garden along sideways, driveways and more. However, lawnmowers are not designed to effectively reach and trim grass and weeds along edges and cannot reach hard-to-reach areas such as sides/edges of sidewalks, driveways, and landscape beds.

Additional tools like string trimmers, also known as weed eaters or weed whackers are used for cutting and trimming weeds and grass. However, using a string trimmer is a laborious and time-consuming process. Additionally, there might be situations where a string trimmer is not readily available, which can further complicate the task of weeds and grass removal. Over time, the repeated use of string trimmers on driveways and other surfaces can lead to small cuts and scrapes, gradually wearing down the material. Individuals desire a barrier device for obviating weed and grass growth along the edges of sidewalks, driveways, garden areas/beds, and more.

Therefore, there exists a long felt need in the art for a weed and grass growth barrier device. There is also a long felt need in the art for a weed and grass growth barrier device that blocks weed and grass growth along sidewalks, driveways, garden areas, and more. Additionally, there is a long felt need in the art for a weed barrier device that can be laid along the length of the sidewalks, driveways and more, to block weed and grass growth. Moreover, there is a long felt need in the art for a weed barrier device that obviates use of string trimmers and other similar tools for controlling weeds. Further, there is a long felt need in the art of a weed and grass barrier device that does not cause cuts or any damage to sidewalks, driveways, garden areas, and more. Furthermore, there is a long felt need in the art for a weed barrier device that is effective in preventing or prohibiting growth of weeds and is easy to use. Finally, there is a long felt need in the art for a weed barrier device that obviates the need to use string trimmers and other grass or weed cutting tools around garden areas, sidewalks, driveways, home exterior walls, and more.

The subject matter disclosed and claimed herein, in one embodiment thereof, comprises a weed barrier device for preventing the growth of weeds and grass and obviating use of string trimmers for cutting/trimming weeds. The weed barrier device includes a horizontal vinyl sheet to cover a desired area for prevention of weeds, a pair of vertical members extending vertically downwards from the longitudinal edges of the vinyl sheet forming a generally 90-degree angle with the vinyl sheet, a plurality of recessed grooves or grooves are integrated across the longitudinal edges and along the length of the weed barrier device for facilitating water drainage to prevent water accumulation on the barrier device. The vertical members provide a secure grip and prevent the barrier device from shifting or from being easily displaced from the desired area. In some embodiments, the barrier device is biodegradable.

In this manner, the weed barrier device of the present invention accomplishes all of the forgoing objectives and provides users with an elongated rubber or vinyl barrier for laying in place along sidewalks, driveways, garden areas, and more to cover the area and thus, prevents growth of weeds and grass. The device obviates the use of string trimmers and can be cut to any size for covering even hard-to-reach areas.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a weed barrier device designed for placement along sides/edges of driveways, sidewalks, garden areas, and other areas to prevent the growth of weeds and grass. The weed barrier device further comprising a horizontal member intended to be laid to cover a desired area, a pair of vertical members extending vertically downwards from the longitudinal edges of the horizontal member, a plurality of recessed grooves or grooves provided across the longitudinal edges and along the length of the weed barrier device for facilitating water drainage from driveways, sidewalks, and other areas to prevent water accumulation on the barrier device, and the vertical members running continuously and uniformly along the longitudinal edges of the barrier device, each forming a substantially 90-degree angle with the horizontal member, thereby providing a secure grip and preventing the barrier device from shifting or from being easily displaced.

In yet another embodiment, the vertical members abut against the ground and engage securely to prevent shifting and sliding of the barrier device and seal the ground area covered by the horizontal member to prevent the growth of weeds and grass thereover, thereby obviating the need for a string trimmer or similar tools.

In yet another embodiment, a longitudinal groove is disposed along the length of the barrier device for water drainage, wherein the groove is positioned near any of the two longitudinal edges.

In a further embodiment, a barrier device in the form of a roll for preventing the growth of weeds and grass is disclosed. The barrier device roll includes a plurality of perforation lines present on the roll at fixed or different lengths, enabling a user to cut a selected length of the barrier device, each of the plurality of perforation lines comprising a plurality of cuts and a plurality of ties, the roll having a length in the range of 50 feet to 500 feet, providing flexibility and adaptability to different applications and user preferences.

In yet another embodiment, a method for using a barrier device to prevent the growth of weeds and grass near sidewalks, driveways, garden areas, and more is described. The method comprising the steps of providing the barrier device, the barrier device includes a roll of a vinyl sheet, the roll having a plurality of perforation lines for enabling a user to cut the desired length of the vinyl sheet; identifying the desired length of the barrier device for application, positioning the barrier device over the designated area to ensure proper coverage and contact with the ground, and gently lifting the barrier device along the edges and rolling it up for secure storage when the device is not required.

In yet another embodiment, the barrier device is made of a vinyl sheet, rubber material, a polymeric material, or a biodegradable material.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a weed barrier device of the present invention in accordance with the disclosed architecture;

FIG. 2 illustrates a perspective view of a roll of the weed barrier device of the present invention in accordance with the disclosed architecture;

FIG. 3 illustrates a block diagram depicting the materials used for manufacturing the weed and grass barrier device of the present invention in accordance with the disclosed architecture;

FIG. 4 illustrates a perspective view of the weed and grass barrier device of the present invention positioned along one side of a sidewalk in accordance with the disclosed architecture;

FIG. 5 illustrates a cross sectional view of a vertical member securing against a floor for stabilizing the barrier device in accordance with the disclosed architecture; and

FIG. 6 illustrates a flow diagram depicting a process of using the weed and grass barrier device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a weed and grass growth barrier device. There is also a long felt need in the art for a weed and grass growth barrier device that blocks weed and grass growth along sidewalks, garden areas/beds, and more. Additionally, there is a long felt need in the art for a weed barrier device that can be laid along the length of the sidewalks, driveways, landscape beds, and more to block weed and grass growth. Moreover, there is a long felt need in the art for a weed barrier device that obviates use of string trimmers and other similar tools for controlling weeds. Further, there is a long felt need in the art of a weed and grass barrier device that does not cause cuts or any damage to sidewalks, driveways, garden areas, and more. Furthermore, there is a long felt need in the art for a weed barrier device that is effective in preventing growth of weeds and is easy to use. Finally, there is a long felt need in the art for a weed barrier device that obviates the need to use string trimmers and other grass or weed cutting tools around garden areas, landscape beds, sidewalks, driveways, home exterior walls, and more.

The present invention, in one exemplary embodiment, is a method for using a barrier device to prevent the growth of weeds and grass near sidewalks, driveways, garden areas and more. The method comprising the steps of providing the barrier device, the barrier device includes a roll of a vinyl sheet, the roll having a plurality of perforation lines for enabling a user to cut the desired length of the vinyl sheet; identifying the desired length of the barrier device for application, cutting the desired length of the vinyl sheet, positioning the barrier device over the designated area to ensure proper coverage and contact with the ground, and gently lifting the barrier device along the edges and rolling it up for secure storage when the device is no longer required.

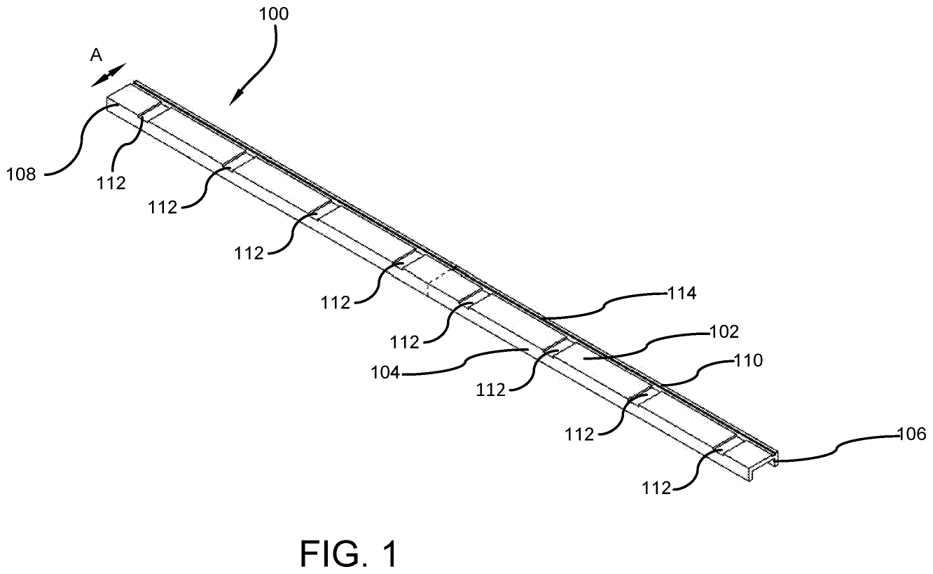

Referring initially to the drawings, FIG. 1 illustrates a perspective view of a weed barrier device of the present invention in accordance with the disclosed architecture. The weed barrier device 100 is designed to be placed along driveways, sidewalks, garden areas, landscape edges/beds, and other areas to prevent growth of weeds and grass. More specifically, the barrier device 100 is made of weatherproof material such as vinyl or rubber and is generally rectilinear in shape. The barrier device 100 has a horizontal member 102 designed to simply lay over and cover a desired area, and at least one and preferably a pair of vertical members 104, 106 extending vertically downwards from the longitudinal edges 108, 110, respectively.

The horizontal member 102 can have a width (shown by arrow “A”) in the range from about 1 inch to about 6 inches to meet requirements of different users. Further, the horizontal member 102 has a plurality of recessed cuts, slits, or grooves 112 extending between the longitudinal edges 108, 110 and spaced apart along the length of the weed barrier device 100. The recessed cuts or grooves 112 are used for water drainage from driveways, sidewalks, and more to prevent water accumulation on the barrier device 100, and for access to the area under the barrier device 100. Each recessed cut or groove can have a width in the range from about 0.04 inches to about 0.50 inches in different embodiments.

The vertical members 104, 106 run continuously and uniformly along the longitudinal edges 108, 110 and help in a better grip of the ground. Each vertical member 104, 106 forms a substantially 90-degrees angle with the horizontal member 102 and prevent the barrier device 100 from shifting or being displaced easily. The vertical members 104, 106 abut against the ground and can make secure engagement for preventing shifting and sliding of the barrier device 100. The vertical members 104, 106 can have a height (shown by arrow “B”) in the range from about 0.50 inches to about 1.50 inches in different embodiments of the present invention. The vertical members 104, 106 seal the ground area covered by the horizontal member 102 and therefore, prevents growth of weeds and grass, thereby obviating the requirement of using a string trimmer or any other similar tool. A longitudinal groove 114 can also be present along length of the barrier device 100 for water drainage or water displacement and the groove 114 can be disposed near any of the longitudinal edges 108, 110.

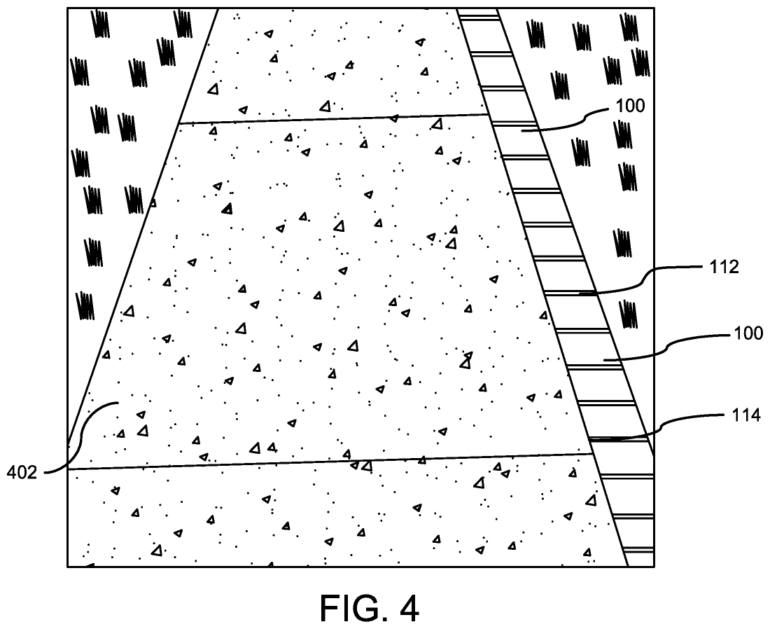

The weed barrier device 100 of the present invention can be designed in different colors and sizers and preferably has a length in the range from about 4 feet to about 8 feet for easy handling and avoiding curling. In the preferred embodiment, the barrier device 100 is designed in a dark color, such as black or brown to help the barrier 100 blend in with the surrounding landscape, making the barrier device 100 less noticeable. In some embodiments, the weed barrier device 100 is biodegradable and can be infused with an insecticide or pesticide material. Additionally, a weed killer can be sprayed or poured into draining grooves 112 to prohibit growth of grass and weeds under the horizontal member 102 while enabling grass to grow up to one of the edges 108 or 110. It is to be appreciated that the vertical members 104, 106 can maintain a barrier between the grass or lawn on one side and the sidewalk, driveway, or landscape edge on the other side, while one of the vertical members 104 or 106 is proximal to the grass edge (see FIG. 4). The edges 104, 106 will also contain the weed killer material placed inside the barrier device 100 to prohibit flow of the weed killer material outside of the barrier device 100. The weed barrier device 100 is flexible and can be rolled for easy storage. Further, the barrier device 100 can be easily wiped and cleaned using water and any other cleaning solution.

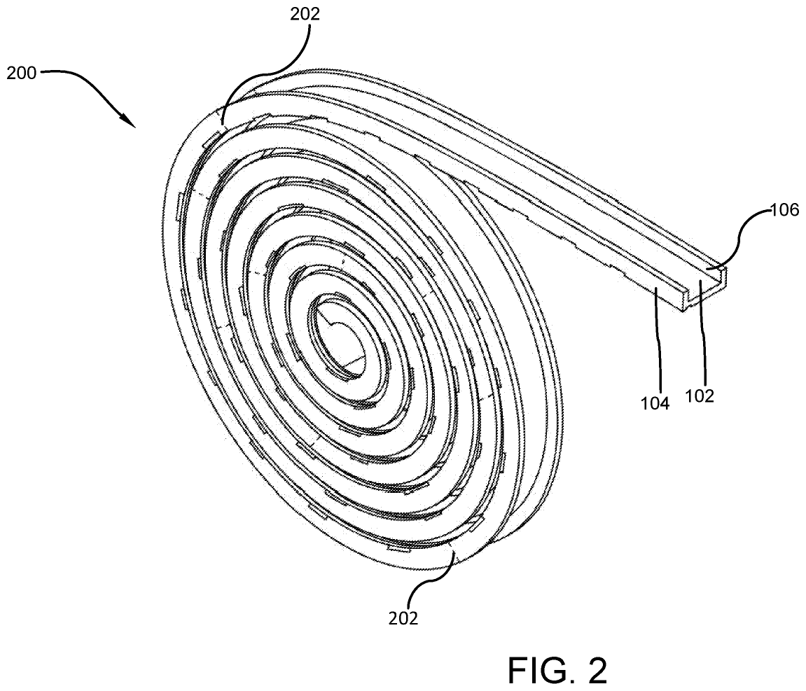

FIG. 2 illustrates a perspective view of a roll of the weed barrier device of the present invention in accordance with the disclosed architecture. The barrier device 100 can come in the form of a roll 200 which has a plurality of perforation lines 202 at fixed or different lengths enabling a user to cut a length of the barrier device as per requirements of the user. In the preferred embodiment, each of the plurality of perforation lines 202 has a plurality of cuts and a plurality of ties, wherein the plurality of cuts is between 20 and 100 cuts per inch, and each of the plurality of ties have a length ranging from 0.040″ to 0.080″. The roll length can be in the range from 40 feet to 500 feet in different embodiments.

Individual barrier devices from the roll can be cut using a sharp device such as a cutter, knife, and any other similar device. Further, the individual barrier devices can be stacked or rolled for easy carriage and storage.

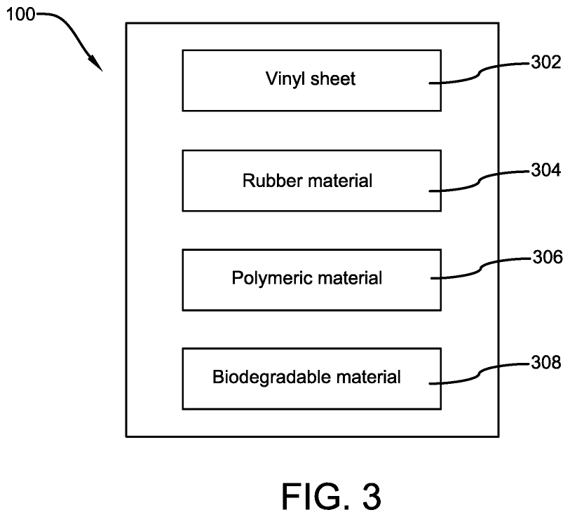

FIG. 3 illustrates a block diagram depicting the materials used for manufacturing the weed and grass barrier device of the present invention in accordance with the disclosed architecture. The barrier device 100 includes a plurality of materials to have durability, resistance to moisture and UV radiation, enhance flexibility, grip, and shock absorption. More specifically, the device 100 includes a vinyl sheet 302 which is used as a base material for the barrier device 100 and provides durability and resistance to moisture and UV radiation. The vinyl sheet 100 also provides a strong and long-lasting foundation for the barrier device 100.

Rubber material 304 is used to enhance flexibility and grip of the barrier device 100. The rubber material 304 can be natural, synthetic, or vulcanized rubber and can be used as a coating or added as a layer to specific sections of the barrier device 100 to improve performance and stability. Polymeric material 306 such as polypropylene or polyethylene, is used for strength, resistance to tearing, and stability. Polymeric materials can be used as woven or non-woven form in the barrier device 100. For providing natural breakdown of the barrier device 100 over time and providing biodegradable properties, a biodegradable material 308 such as jute or coir is used in the barrier device 100.

In different embodiments of the present invention, the barrier device 100 includes 50% vinyl sheet, 30% woven polypropylene fabric, 10% rubber material and 10% biodegradable material. Preferably, the barrier device 100 includes 50% vinyl sheet, 20% woven polypropylene fabric, 20% rubber material and 10% biodegradable material in the horizontal member 102; and, 30% vinyl sheet, 30% woven polypropylene fabric, 30% rubber material and 10% biodegradable material in the vertical members 104, 106 for greater rigidity.

FIG. 4 illustrates a perspective view of the weed and grass barrier device of the present invention positioned along one side of a sidewalk in accordance with the disclosed architecture. As illustrated, a plurality of independent barrier devices 100 are positioned end to end to cover a side portion of the sidewalk 402 for preventing growth of the weed and grass. It is to be appreciated that a plurality of barrier devices can be positioned end to end on the opposing side of the sidewalk 402 (not illustrated). The width and length of the barrier devices 100 can be selected as per preference by users and the barrier device 100 obviates need of use of a lawnmower, string trimmer, and other similar devices to be used along opposing sides of the sidewalk 402 and thus also helps in protecting integrity and quality of the sidewalk 402. The water in rain and during cleaning of sidewalk 402 can be easily drained using the grooves 112, 114. A lawnmower can cut over the barrier 100 for keeping a clean line and holding back weed growth. The barrier 100 is aligned with the ground and does not obstruct the working and movement of the lawnmower.

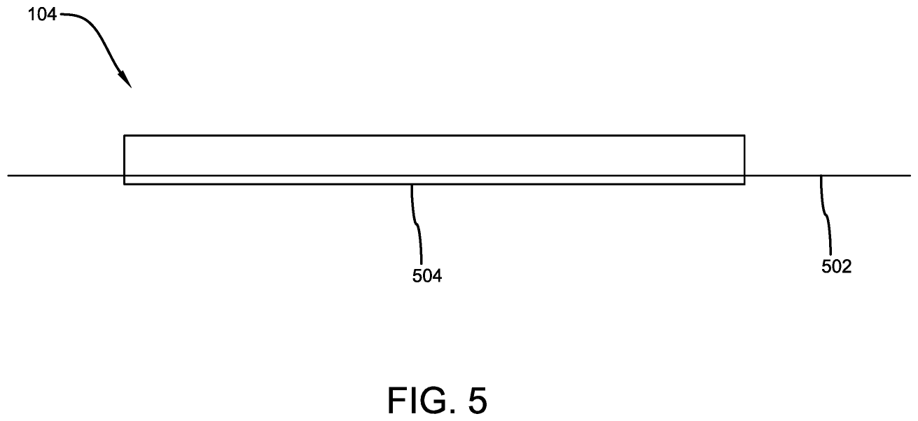

FIG. 5 illustrates a cross sectional view of a vertical member securing against an edge for stabilizing the barrier device in accordance with the disclosed architecture. The vertical members 104, 106 formed by 90-degree bends on each edge 108, 110 of the weed barrier device 100 provides a better grip on the ground preventing the barrier device 100 from shifting and sliding. As illustrated, the bottom edge 504 of the vertical member 104 can passes through the ground 502 in cases where the turf is soft such as in a garden area, thereby enabling the barrier device 100 to grip the ground 502 securely. In some embodiments, the bottom edge 504 rests on the ground 502 and increases friction, thereby reduces shifting and sliding of the barrier device 100.

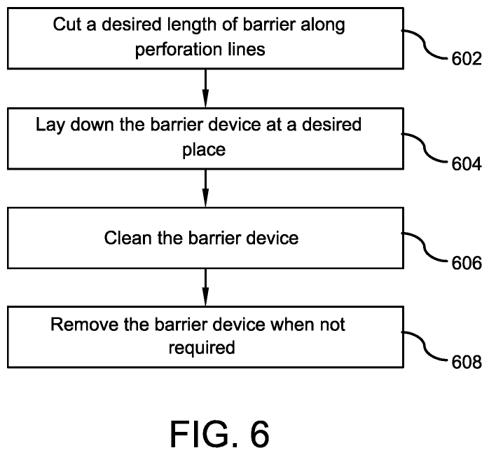

FIG. 6 illustrates a flow diagram depicting a process of using the weed and grass barrier device of the present invention in accordance with the disclosed architecture. Initially, the desired length of barrier device 100 is identified for application and using scissors or a knife, the desired length is cut along the perforation lines from the roll 200 (Step 602). Then, the target area for application of the barrier device 100 is cleared of any debris, rocks, or existing vegetation and the barrier device 100 is positioned over the designated area to ensure proper coverage and contact with the ground (Step 604).

Then, over time, cleaning of the barrier device 100 can be performed using any conventional device such as a broom, brush, or a gentle spray of water to remove surface debris (Step 606). Finally, when the device 100 is not required, then, the barrier device 100 is gently lifted along the edges 108, 110 and is rolled up for secure storage (Step 608).

In some embodiments, the weed barrier device 100 can be secured using pins or stakes for additional stability in cases of strong wind and thunderstorm.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “weed and grass barrier device”, “weed barrier device”, “barrier device”, and “barrier” are interchangeable and refer to the weed barrier device 100 of the present invention.

Notwithstanding the forgoing, the weed barrier device 100 of the present invention can be of any suitable size and configuration as is known in the art without affecting the overall concept of the invention, provided that it accomplishes the above stated objectives. One of ordinary skill in the art will appreciate that the weed barrier device 100 as shown in the FIGS. are for illustrative purposes only, and that many other sizes and shapes of the weed barrier device 100 are well within the scope of the present disclosure. Although the dimensions of the weed barrier device 100 are important design parameters for user convenience, the weed barrier device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A weed and grass barrier device for maintaining an edge, the weed and grass barrier device comprising:
a barrier device having a horizontal member and a pair of vertical members extending downwards from opposing longitudinal edges of said horizontal member;
wherein said horizontal member lays over a desired area to prohibit weed and grass growth thereunder;
wherein said horizontal member having a width from 1 inch to 6 inches;
wherein said horizontal member having a plurality of grooves extending between said opposing longitudinal edges and spaced apart along a length of said barrier device;
wherein said plurality of grooves provide a passthrough for fluids;
wherein each of said plurality of grooves having a width from 0.04 inches to 0.50 inches;
wherein said barrier device provides a barrier between a lawn and a protected area; and
further wherein said protected area is selected from a group consisting of a driveway, a sidewalk, a garden area, a landscape edge, and a home exterior wall.

2. The weed and grass barrier device for maintaining an edge of claim 1, wherein said barrier device is rectilinear in shape.

3. The weed and grass barrier device for maintaining an edge of claim 1, wherein said pair of vertical members extending continuously and uniformly along respective said opposing longitudinal edges.

4. The weed and grass barrier device for maintaining an edge of claim 3, wherein each one of said pair of vertical members form a substantially 90-degree angle with said horizontal member.

5. The weed and grass barrier device for maintaining an edge of claim 4, wherein each one of said pair of vertical members extends into the turf of the lawn when said barrier device is installed.

6. The weed and grass barrier device for maintaining an edge of claim 5, wherein each one of said pair of vertical members having a height from 0.50 inches to 1.50 inches.

7. The weed and grass barrier device for maintaining an edge of claim 6, wherein at least one of said pair of opposing longitudinal edges having a longitudinal groove proximal thereto, and further wherein said longitudinal groove extending along a length of said barrier device for draining water therealong.

8. The weed and grass barrier device for maintaining an edge of claim 6 wherein said barrier device infused with a chemical selected from a group consisting of an insecticide and a pesticide.

9. The weed and grass barrier device for maintaining an edge of claim 6, wherein said barrier device is biodegradable.

10. The weed and grass barrier device for maintaining an edge of claim 6, wherein said barrier device is flexible and rollable.

11. The weed and grass barrier device for maintaining an edge of claim 5, wherein said barrier device having a composition of 50% vinyl sheet, 30% woven polypropylene fabric, 10% rubber material, and 10% biodegradable material.

12. The weed and grass barrier device for maintaining an edge of claim 5, wherein said barrier device having a composition of 50% vinyl sheet, 20% woven polypropylene fabric, 20% rubber material, and 10% biodegradable material in said horizontal member 102; and, 30% vinyl sheet, 30% woven polypropylene fabric, 30% rubber material, and 10% biodegradable material in said pair of vertical members.

13. A weed and grass barrier device for maintaining an edge, the weed and grass barrier device comprising:
a barrier device having a horizontal member and at least one vertical member extending downwards from opposing longitudinal edges of said horizontal member;
wherein said horizontal member lays over a desired area to prohibit weed and grass growth thereunder;
wherein said horizontal member having a width from 1 inch to 6 inches;
wherein said barrier device provides a barrier between a lawn and a protected area;
wherein said at least one vertical member extends continuously and uniformly along at least one of opposing longitudinal edges;
wherein said at least one vertical member extends into the turf of the lawn when said barrier device is installed; and
further wherein said protected area is selected from a group consisting of a driveway, a sidewalk, a garden area, a landscape edge, and a home exterior wall.

14. The weed and grass barrier device for maintaining an edge of claim 13, wherein at least one of said pair of opposing longitudinal edges having a longitudinal groove proximal thereto, and further wherein said longitudinal groove extending along a length of said barrier device for draining water therealong.

15. The weed and grass barrier device for maintaining an edge of claim 13, wherein said barrier device is infused with a chemical selected from a group consisting of an insecticide and a pesticide.

16. The weed and grass barrier device for maintaining an edge of claim 6, wherein said barrier device is biodegradable.

17. The weed and grass barrier device for maintaining an edge of claim 6, wherein said barrier device is flexible and rollable.

18. A method of forming a weed and grass barrier for maintaining an edge, the method comprising the steps of:
providing a barrier device having a horizontal member and a pair of vertical members extending downwards from opposing longitudinal edges of said horizontal member;
wherein said horizontal member having a width from 1 inch to 6 inches;
wherein said horizontal member having a plurality of slits extending between said opposing longitudinal edges and spaced apart along a length of said barrier device;
wherein said pair of vertical members extending continuously and uniformly along respective said opposing longitudinal edges;
wherein each one of said pair of vertical members form a substantially 90-degree angle with said horizontal member;
cutting a desired length of said barrier device;
positioning said barrier device between a lawn and a protected area;
pressing down on said opposing longitudinal edges;
inserting said pair of vertical members into the turf;
wherein said horizontal member lays over a desired area to prohibit weed and grass growth thereunder;
wherein said barrier device provides a barrier between a lawn and a protected area;
further wherein said protected area is selected from a group consisting of a driveway, a sidewalk, a garden area, a landscape edge, and a home exterior wall.

19. The method of forming a weed and grass barrier of claim 18, wherein at least one of said pair of opposing longitudinal edges having a longitudinal groove proximal thereto, and further wherein said longitudinal groove extending along a length of said barrier device for draining water therealong.

20. The method of forming a weed and grass barrier of claim 18 further comprising a step of spraying a weed killer into said plurality of slits.
